(19) United States
(12) Patent Application Publication
(10) Pub. No.: US 2018/0053260 A1
(43) Pub. Date: Feb. 22, 2018

(54) DIGITAL METHOD FOR FACILITATING THE ORGANISATION OFAN EVENT OR PROJECT

(71) Applicant: Samuel Richard Barlow, London (GB)

(72) Inventor: Samuel Richard Barlow, London (GB)

(21) Appl. No.: 15/678,364

(22) Filed: Aug. 16, 2017

Related U.S. Application Data
(60) Provisional application No. 62/375,585, filed on Aug. 16, 2016.

(51) Int. Cl. G06Q 50/00; G06Q 30/02; G06Q 10/10; G06Q 20/10

(52) U.S. Cl. CPC G06Q 50/01; G06Q 20/10; G06Q 10/1095; G06Q 30/0277

(57) ABSTRACT

A facilitation method for organizing an event or project consisting of the following steps:
proposal of an event or project in a geographic area by a proposer;
selection by the proposer of geographic choice parameters for the respondents;
allocation of an account for receipt of money from respondents upon triggering the proposed event or project;
electronic advertisement of the event
indication of interest by respondents for the event or project at a geographic position with the geographic position being within the geographic area, together with indication of the respondent's payment details for taking of payment by the proposer into a proposers account;
determination by the proposer of whether the indicated interest is sufficient to warrant the event being triggered;
triggering of the event.

### BACKGROUND OF THE INVENTION

The present invention relates to a facilitation method for individuals to indicate their interest in a proposed event or project in a geographic area via a data processor.

It is known that interest in a potential event can be given through social media, for instance Facebook®. An event can be created and users may then click “attending”, “maybe” or “not attending”. The information gathered can be misleading as people do not necessarily intend to attend an event they have responded to.

The object of the present invention is to provide an improved facilitation method for individuals to indicate their interest in a proposed event or project via a data processor.

### BRIEF SUMMARY OF THE INVENTION

According to the present invention there is provided a facilitation method whereby a proposer proposes bringing an event or project to a geographic area, members of the public may then indicate their interest in the proposed event or project in that geographical area, in the instance that one or more respondents cumulatively indicate their interest in an event or project with an exchange of assets via a data processor the event or project may occur, the method comprising the following steps:
proposal by a proposer of an event or project in a geographic area;
selection by the party of geographic choice parameters for the respondents;
allocation of an account by the proposer for receipt of money from respondents upon triggering the event or project;
electronic advertisement of the event;
indication of interest by respondents for the proposed event or project at a geographic position within the geographic area together with the respondent's payment details for taking of payment by the proposer into a proposers account upon triggering the event;
determination by the proposer of whether the indicated interest is sufficient to warrant the event being triggered;
the triggering of the event in the geographic position being communicated to the respondents.

As used herein, the term “data processor” is used broadly to encompass all computers, particularly but not limited to mobile telephones, laptop computers and desk top computers.

As used herein, the term “proposer” is used to broadly encompass all potential proposers for an event or project, particularly but not limited to an artist, performer, band, band manger, agent, venue manager, brand, charity, or another suitable entity.

As used herein, the term “respondent” is used to broadly encompass all potential attendees, particularly, but not limited to members of the public.

Whilst it is envisaged that the method could work without the requirement of account creation, preferably the proposer would create an account for use with this method. The authenticity of the proposer's account could then be verified. It is also envisaged that the respondent would create an account for use with this method This could be connected to be a credit card, debit card, PayPal account or indeed any payment service account, enabling the user to indicate interest accompanied by a pledge for an exchange of assets in the scenario that the event or project proceeds.

Whilst it is envisaged that the event or project could be allocated a general area, it is possible that the event or project could instead be allocated a specific venue by the proposer upon proposal.

Whilst it is envisaged that the event or project will be triggered dependent upon the value of the pledged assets, it is possible that there will be a pre-determined threshold. If the pre-determined threshold is surpassed by the pledged assets, the proposer may be notified and the event or project organized.

Whilst it is envisaged that the act of indicating interest will include an exchange of assets, it is possible that the registration of interest could be only a declaration of intention to attend an event or make a project happen, such as a respondent indicating the desire to volunteer or the event being free.

Normally a user would only indicate interest when they wish to exchange the pledged assets for admittance. However, indicating interest does not mean the assets are automatically exchanged if the event is triggered. Preferably the respondent will be notified of the event proceeding, at which point the account holder may accept, alter or refuse the transfer of assets.

Normally respondents could only indicate interest in an event or project that is not oversubscribed. Preferably a digital queue is formed, this takes into account the pledged exchange of assets, and the order in which the pledges were made. This could give preference to those that pledged the highest amount, and those that pledged first. It is also envisaged that other preferences could also be used such as, but not limited to, affiliation to a sponsoring brand.

Normally an event will occur only once the organizing party has approved the event or project on the basis of pledges made. It is possible that some respondents will have pledged over or under the allocated value. First refusal is given to the respondents at the front of the digital queue. This may be determined by the value pledged, the time interest was indicated or by another suitable factor. Respondents who have pledged less or under the admittance cost (in the case of tickets) will be offered the chance to attend in accordance with the digital queue formed.

The exchange for admittance may be less than the p I edged proposed exchange. Respondents that pledged more may be matched with tickets allocated a higher value.

Normally the respondents would be indicating interest for a single event or project. It is envisaged that multiple respondents may indicate interest in similar proposed events or projects in the same geographic area. In such a scenario it would be possible to arrange for these events to be triggered for a joint event or project, with the relevant representative parties being made aware and agreeing to such a proposal.

According to a second embodiment of the invention there is provided a facilitation method whereby a member of the general public proposes bringing an event or project to a geographic area and other members of the public may then indicate their interest in the proposed event or project, in the instance that one or more respondents cumulatively indicate their interest in an event or project with an exchange of assets for a proposed event or project via a data processor the event or project may occur, the method comprising the following steps:
proposal by a member of the public of an event or project in a geographic area;
selection by the member of the public of geographic choice parameters for the respondents;
electronic advertisement of the proposed event or project;
indication of interest by respondents for the event or project at a geographic position within the geographic area together with indication of the respondents' payment details for taking of payment by the proposer into a proposers account;
levels of indicated interest relayed to a party representative of the event or project;
allocation of an account by the representative party for receipt of money from respondents upon triggering the event or project;
determination by the party of whether the indicated interest is sufficient to warrant the event being triggered;
the triggering of the event in the geographic position being communicated to the respondents.

In this embodiment the proposer is a member of the public who wishes to pledge to attend the event, it is envisaged that it could also be a venue manager or another suitable entity.

Normally an event or project proposed by a member of the public would not be relayed to the party automatically, otherwise there would likely be an unnecessary excess of information. It is envisaged that the party could be automatically informed of a proposed event or project once a certain volume of pledges has been made. This could be a pre-determined threshold of users who have pledged interest or if a certain value of assets pledged.

Whilst it is envisaged that the event or project could be allocated a general area, it is possible that the event or project could instead be allocated a specific venue by the member of the public upon proposal.

Whilst it is envisaged that the method could work without the requirement of account creation, it is envisaged that the respondent would create an account for use with this method. This could be connected to a credit card, debit card, PayPal account or indeed any payment service account, enabling the user to indicate interest accompanied by a pledge for an exchange of assets in the scenario that the event or project proceeds.

Whilst it is envisaged that the event will occur dependent upon the value of the pledged assets, it is possible that there will be a pre-determined threshold. If the pre-determined threshold is surpassed by the pledged assets, the party may be notified and the event organized.

Whilst it is envisaged that the indication of interest will include an exchange of assets, it is possible that the indication of interest could be only a declaration of intention to attend an event.

Normally a user would only indicate interest when they wish to exchange the pledged assets for admittance. However, a pledge does not mean the assets are automatically exchanged. Preferably the account holder will be notified of the event proceeding, at which point the account holder may accept, alter or refuse the transfer of assets.

Preferably a digital queue is formed, this takes into account the pledged exchange of assets, and the order in which the pledges were made. This should give preference to those that pledged the highest amount, and those that pledged first. It is envisaged that other preferences could also arise from scenarios such as affiliation to a sponsoring brand, or another suitable scenario.

Normally an event will occur only once the organizing party has approved the event or project on the basis of pledges made. It is possible that some respondents will have pledged over or under the allocated value. First refusal is given to the respondents at the front of the digital queue. This may be determined by the value pledged, or the time of the pledge. Respondents who have pledged less or under the admittance cost (in the case of tickets) will he offered the chance to attend in accordance with the digital queue formed.

The exchange for admittance may be less than the pledged proposed exchange. Respondents that pledged more may be matched with tickets allocated a higher value.

### BRIEF DESCRIPTION OF THE SEVERAL VIEWS OF THE DRAWING

To help with the understanding of the invention, a specific embodiment thereof will now be described by way of example and with reference to the accompanying drawings, in which:

FIG. 1 is a flowchart diagram of how the facilitation method for organizing an event or project is executed in accordance with the first embodiment of the invention;

FIG. 2 is a flowchart diagram of how the facilitation method for organizing an event or project is executed in accordance with the second embodiment of the invention;

FIG. 3 is a diagram representative of how the event organization method performs in accordance with the present invention.

FIG. 4 is a diagram depicting how respondents may indicate interest in an event or project in different geographic areas.

### DETAILED DESCRIPTION OF THE INVENTION

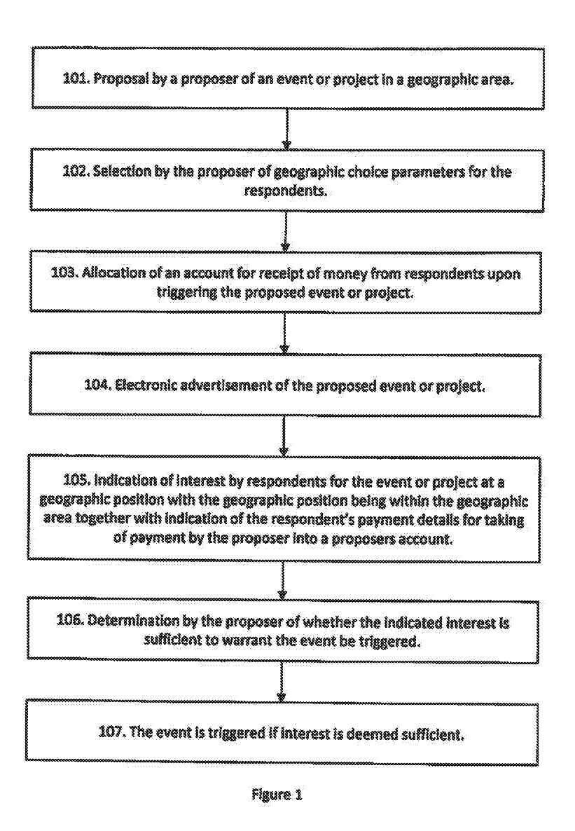

Referring to FIG. 1, the flowchart in accordance with the first embodiment of the invention, event or project organization may be enhanced by the following method steps:

101. Proposal by a proposer of an event or project in a geographic area;

102. Selection by the proposer of geographic choice parameters for the respondents;

103. Allocation of an account for receipt of money from respondents upon triggering the proposed event or project;

104. Electronic advertisement of the proposed event or project;

105. Indication of interest by respondents for the event or project at a geographic position with the geographic position being within the geographic area together with indication of the respondent's payment details for taking of payment by the proposer into a proposers account;

106. Determination by the proposer of whether the indicated interest is sufficient to warrant the event being triggered;

107. The event is triggered if interest is deemed sufficient.

The invention is not intended to be restricted to the details of the above described embodiment. For instance, it is possible that the party does not propose the event, but instead a member of the public does, as in the second embodiment. It is also possible that the accounts are created by the respondents for use within the method, these accounts could be pre-existing accounts such as PayPal® or Facebook® accounts.

The present invention is not about where the information is stored and how payment is processed etc. although these are important aspects. In accordance with good practice when handling sensitive information, it is expected that all appropriate information will be stored in a secure location.

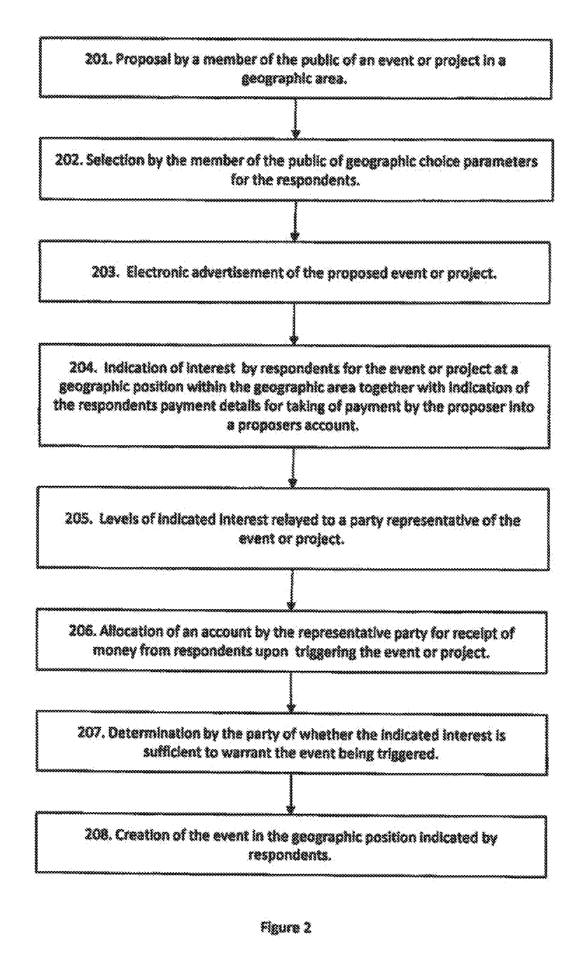

Referring to FIG. 2, the flowchart in accordance with the second embodiment of the invention, event or project organization may be enhanced by the following method steps:

201. Proposal by a member of the public of an event or project in a geographic area;

202. Selection by the member of the public of geographic choice parameters for the respondents;

203. Electronic advertisement of the proposed event or project;

204. Indication of interest by respondents for the event or project at a geographic position within the geographic area together with indication of the respondents' payment details for taking of payment by the proposer into a proposer's account;

205. Levels of indicated interest relayed to a party representative of the event or project;

206. Allocation of an account by the representative party for receipt of money from respondents upon triggering the event or project;

207. Determination by the party of whether the indicated interest is sufficient to warrant the event being triggered;

208. Creation of the event in the geographic position indicated by respondents.

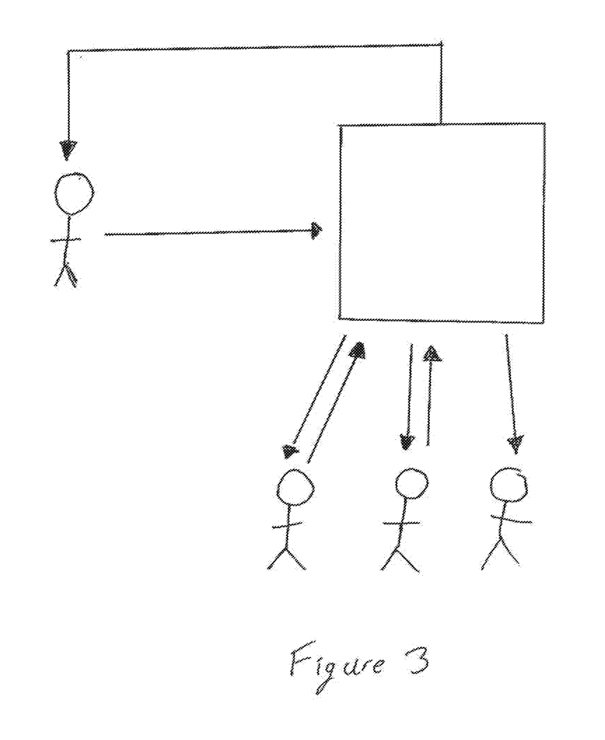

Referring to FIG. 3, the diagram representative of how the present invention is used by both respondents and the proposer. In order for the method to be executed there must be a party with the capability of electronically advertising the event or project. Once an event or project has been proposed and advertised, potential respondents are able to see it. Respondents then indicate their interest in a proposed event or project. The data regarding indicated interest, and the amount pledged is made available to the organizing party, if the organizing party is a member of the public, it is assumed that the information would be made available to the appropriate representative. If demand is sufficient and the party or appropriate representative decides to proceed with the event, then the event is triggered. Respondents who pledged for the event may then obtain tickets.

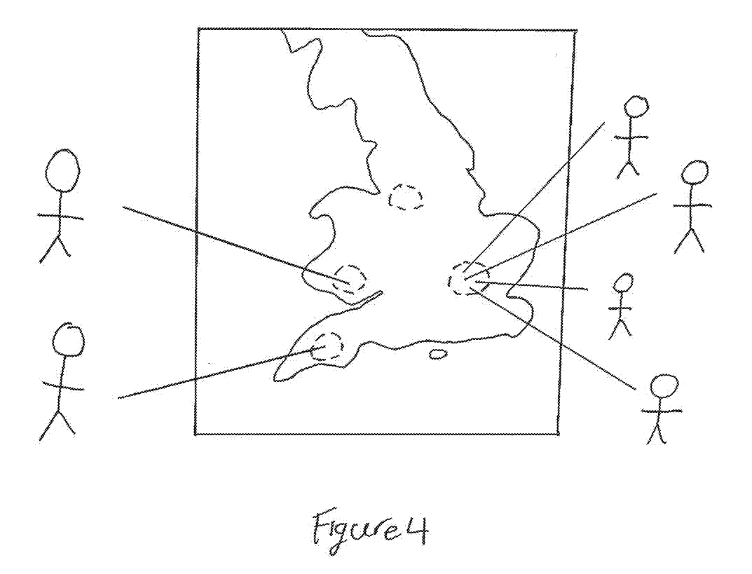

Referring to FIG. 4, the diagram depicting how respondents may indicate interest in an event or project in different geographic areas. It can be seen that respondents are able to indicate their interest in different proposed events or projects. These have been depicted by the dotted lines. The proposed event in London has clearly garnered more interest than the events in Plymouth or Cardiff. The proposer can then use this information in order to determine whether the event should be triggered. If triggered the respondents who registered interest may exchange their pledge for a ticket.

1. A facilitation method for organizing an event or project consisting of the following steps:
proposal of an event or project in a geographic area by a proposer;
selection by the proposer of geographic choice parameters for the respondents;
allocation of an account for receipt of money from respondents upon triggering the proposed event or project;
electronic advertisement of the event;
indication of interest by respondents for the event or project at a geographic position with the geographic position being within the geographic area, together with indication of the respondent's payment details for taking of payment by the proposer into a proposers account;
determination by the proposer of whether the indicated interest is sufficient to warrant the event being triggered;
triggering of the event.

2. A facilitation method for organizing an event or project as claimed in claim 1, wherein, one or both of the proposer and respondent creates an account for use with the method.

3. A facilitation method for organizing an event or project as claimed in claim 2, wherein the account of one or both of the proposer and respondent is verifiable.

4. A facilitation method for organizing an event or project as claimed in claim 1, wherein the geographic area is a specific venue.

5. A facilitation method for organizing an event or project as claimed in claim 1, wherein the event or project will be triggered if the indicated interest surpasses a pre-determined threshold.

6. A facilitation method for organizing an event or project as claimed in claim 1, wherein the indication of interest does not require an exchange of assets.

7. A facilitation method for organizing an event or project as claimed in claim 1, wherein the respondent is notified that the event or project has been triggered, and the respondent can accept, alter, or refuse the transfer of assets.

8. A facilitation method for organizing an event or project as claimed in claim 1, wherein:
a digital queue is formed for oversubscribed events,
the queue taking into account one or more of the following:
the pledged exchange of assets made by the respondent,
the order in which pledges were made, and
affiliation to a sponsor

9. A facilitation method for organizing an event or project as claimed in claim 8, wherein if the pledged value is insufficient, the respondent can alter their pledge in accordance with their position in the digital queue.

10. A facilitation method for organizing an event or project as claimed in claim 8, wherein the respondents who pledged the most are offered the higher valued tickets.

11. A facilitation method for organizing an event or project as claimed in claim 1, wherein if multiple respondents indicate interest in similar events in a similar area, a joint event could be facilitated.

12. A facilitation method for organizing an event or project consisting of the following steps:
proposal by a member of the public of an event or project in a geographic area;
selection by the member of the public of geographic choice parameters for the respondents;
electronic advertisement of the proposed event or project;
indication of interest by respondents for the event or project at a geographic position within the geographic area together with indication of the respondents' payment details for taking of payment by the proposer into a proposers account;
levels of indicated interest relayed to a party representative of the event or project;
allocation of an account by the representative party for receipt of money from respondents upon triggering the event or project;
determination by the party of whether the indicated interest is sufficient to warrant the event being triggered;
the triggering of the event in the geographic position being communicated to the respondents.

13. A facilitation method for organizing an event or project as claimed in claim 12, wherein, the party representative is automatically informed of a proposed event or project once a certain volume of pledges has been made.

14. A facilitation method for organizing an event or project as claimed in claim 13, wherein, the certain volume is dependent upon one or both of the number of pledges or the value of pledges.

15. A facilitation method for organizing an event or project as claimed in claim 12, wherein the geographic area is a specific venue.

16. A facilitation method for organizing an event or project as claimed in claim 12, wherein, one or both of the proposer and respondent creates an account for use with the method.

17. A facilitation method for organizing an event or project as claimed in claim 16, wherein the account of one or both of the proposer and respondent is verifiable.

18. A facilitation method for organizing an event or project as claimed in claim 12, wherein the indication of interest does not require an exchange of assets.

19. A facilitation method for organizing an event or project as claimed in claim 12, wherein the respondent is notified that the event or project has been triggered, and the respondent can accept, alter, or refuse the transfer of assets.

20. A facilitation method for organizing an event or project as claimed in claim 12, wherein:
a digital queue is formed for oversubscribed events, the queue taking into account one or more of the following:
the pledged exchange of assets made by the respondent,
the order in which pledges were made, and p2 affiliation to a sponsor.

21. A facilitation method for organizing an event or project as claimed in claim 20, wherein if the pledged value is insufficient, the respondent can alter their pledge in accordance with their position in the digital queue.

22. A facilitation method for organizing an event or project as claimed in claim 20, wherein the respondents who pledged the most are offered the higher valued tickets.
